(19) United States
(12) Patent Application Publication
(10) Pub. No.: US 2006/0188741 A1
(43) Pub. Date: Aug. 24, 2006

(54) Porous liquid absorbing-and-holding member, process for production thereof, and alcohol absorbing-and-holding member

(75) Inventors: Kenji Date, Matsue (JP); Kiyoshi Tatsugawa, Yonago (JP); Katsuhiko Ohishi, Yonago (JP); Noriyuki Nakaoka, Yasugi (JP)

Correspondence Address: SUGHRUE MION, PLLC, 2100 PENNSYLVANIA AVENUE, N.W., SUITE 800, WASHINGTON, DC, 20037, US

(73) Assignee: HITACHI METALS, LTD.

(21) Appl. No.: 11/348,257

(22) Filed: Feb. 7, 2006

(30) Foreign Application Priority Data
Feb. 14, 2005 (JP) 2005-036801

(51) Int. Cl. B22F 1/02; B32B 15/04

(52) U.S. Cl. 428/566; 428/570; 428/469

(57) ABSTRACT

An object of the present invention is to provide a porous liquid absorbing-and-holding member having a high absorbing capacity for a liquid owing to capillarity and having in itself a structure capable of holding a large amount of the liquid, a process for producing this member, and a member for absorbing and holding an alcohol used as a fuel for a fuel cell. The porous liquid absorbing-and-holding member provided by the present invention is that including a porous sintered product having a skeleton formed by sintering of metal powder around voids and subjected to hydrophilicity-imparting treatment. The hydrophilicity-imparting treatment is preferably the formation of one or more substances selected from the group consisting of silicon oxides, titanium oxides, chromium oxides and aluminum oxide on the skeleton.

### BACKGROUND OF THE INVENTION

The present invention relates to a porous liquid absorbing-and-holding member having absorbing capacity for a liquid such as an alcohol or water and capable of holding the liquid, a process for production thereof, and an alcohol absorbing-and-holding member.

When brought into contact with a liquid, porous materials (e.g. sponge and a fibrous substrate) made of a resin or a natural material can absorb the liquid to hold the same therein, owing to capillarity due to surface tension. The sponge, fibrous substrate and the like, however, have a low strength in themselves and hence cannot retain their shape. Therefore, porous ceramics represented by unglazed pottery are usually used as porous materials having high strength and water retention capacity.

In the field of fuel cells that have recently been noted, it has been proposed that a porous material be used as a member for feeding an aqueous methanol solution to the fuel electrode (anode) of a direct methanol fuel cell (hereinafter abbreviated as DMFC) (JP-A-59-066066). That is, the porous material is suitable because it can absorb the aqueous methanol solution from a tank owing to capillarity to hold methanol on the surface of the fuel electrode.

As described above, porous materials are useful as a liquid absorbing-and-holding member. Conventional porous materials are disadvantageous in that they can hold a liquid therein in only a small amount for their volume. For example, in the case of DMFC, since a porous material has to feed a fuel to the anode ceaselessly, the porous material has to send the liquid fuel to the anode owing to capillarity and moreover, the porous material itself has to be able to hold the fuel as much as possible. Therefore, the conventional porous materials are not satisfactory. When used in a mobile or an automobile, a porous material has to be resistant to a certain degree of vibration and impact. Therefore, conventional ceramics are not satisfactory in quality.

An object of the present invention is to provide a porous liquid absorbing-and-holding member having a high absorbing capacity for a liquid owing to capillarity and having in itself a structure capable of holding a large amount of the liquid, a process for producing this member, and a member for absorbing and holding an alcohol used as a fuel for a fuel cell.

### SUMMARY OF THE INVENTION

The present inventor investigated porous materials and consequently solved the above problem by producing a metallic porous sintered product having not a simple sintered structure but a skeleton formed by sintering of metal particles around voids, and subjecting the metal surface of the skeleton to hydrophilicity-imparting treatment. On the basis of this technical idea that a highly hydrophilic substance is formed on the surface of skeleton of the porous sintered product comprising the metallic structure, the present inventor has found optimum method and conditions for forming said hydrophilic substance, and has accomplished the present invention.

That is, the present invention provides a porous liquid absorbing-and-holding member characterized by comprising a porous sintered product having a skeleton formed by sintering of metal powder around voids and subjected to hydrophilicity-imparting treatment. The hydrophilicity-imparting treatment is preferably the formation of one or more substances selected from the group consisting of silicon oxides, titanium oxides, chromium oxides and aluminum oxide on the skeleton.

In addition, in the porous liquid absorbing-and-holding member of the present invention, the skeleton portion has pores with an average pore size of preferably 200 μm or less, the average void size is preferably 3,000 μm or less, and the porosity content of the whole porous material is preferably not more than 95% by volume and not less than 60% by volume. More preferably, the average pore size of the skeleton portion is 5 to 100 μm, the average void size is 100 to 2,000 μm, and the porosity content of the whole porous material is 70 to 90% by volume. The present invention also provides an alcohol absorbing-and-holding member comprising the above-mentioned porous liquid absorbing-and-holding member into which an alcohol is absorbed to be held therein. In the present specification, “average pore (void) size” denotes average of pore (void) diameter.

Furthermore, the present invention provides a process for producing a porous liquid absorbing-and-holding member by adopting a method for subjecting the skeleton of a porous sintered product having the skeleton formed by sintering of metal powder around voids to hydrophilicity-imparting treatment, which is characterized by carrying out the hydrophilicity-imparting treatment by using an organometallic compound as a starting material, and reacting a starting gas obtained by vaporizing this compound with a plasma gas containing oxygen at a pressure close to atmospheric pressure, to form a metal oxide on the surface of the above-mentioned skeleton.

The present invention provides the above-mentioned process for producing a porous liquid absorbing-and-holding member in which the plasma gas containing oxygen at a pressure close to atmospheric pressure is preferably passed upward from below the porous sintered product to form the metal oxide on the surface of the skeleton. In addition, the present invention provides the above-mentioned process for producing a porous liquid absorbing-and-holding member which is characterized in that the metal oxide is a silicon oxide.

The present invention has made it possible to provide a porous liquid absorbing-and-holding member having a high absorbing capacity for a liquid owing to capillarity and having a structure capable of holding a large amount of the liquid, a process for producing this member, and a member for absorbing and holding an alcohol used as a fuel for a fuel cell.

### BRIEF DESCRIPTION OF DRAWINGS

FIG. 1 is an electron micrograph showing an example of section of a porous liquid absorbing-and-holding member before hydrophilicity-imparting treatment according to the present invention.

FIG. 2 is an electron micrograph showing an example of the skeleton portion of a porous liquid absorbing-and-holding member of the present invention.

FIG. 3 is an electron micrograph showing an example of section of the skeleton of the porous liquid absorbing-and-holding member of the present invention.

FIG. 4 is an electron micrograph showing another example of section of the skeleton of the porous liquid absorbing-and-holding member of the present invention.

FIG. 5 is an electron micrograph showing an example of the skeleton portion of another porous liquid absorbing-and-holding member of the present invention.

FIG. 6 is a graph showing an example of the result of analyzing the skeleton portion of the porous liquid absorbing-and-holding member of the present invention.

FIG. 7 is an electron micrograph showing an example of the skeleton portion of further another porous liquid absorbing-and-holding member of the present invention.

FIG. 8 is an electron micrograph showing an example of section of another porous liquid absorbing-and-holding member before hydrophilicity-imparting treatment according to the present invention.

FIG. 9 is an electron micrograph showing an example of the skeleton portion of still another porous liquid absorbing-and-holding member of the present invention.

FIG. 10 is an electron micrograph showing another example of the skeleton portion of the porous liquid absorbing-and-holding member of the present invention.

FIG. 11 is an electron micrograph showing an example of the skeleton portion of a porous liquid absorbing-and-holding member of a comparative example.

FIG. 12 is an electron micrograph showing an example of the skeleton portion of a porous liquid absorbing-and-holding member of another comparative example.

FIG. 13 is a diagram illustrating a test for evaluation of liquid absorbing-and-holding capability carried out in the working examples.

FIG. 14 is a graph showing the result of evaluating the liquid absorbing-and-holding capability of porous liquid absorbing-and-holding members of the present invention and a comparative example.

FIG. 15 is a graph showing the result of evaluating the liquid absorbing-and-holding capability of porous liquid absorbing-and-holding members of the present invention and another comparative example.

FIG. 16 is a schematic view showing an example of CVD apparatus used in the production process of the present invention.

### DETAILED DESCRIPTION OF THE INVENTION

At first, the porous liquid absorbing-and-holding member of the present invention is described below. The important characteristic of this member is that an excellent action of absorbing and holding a liquid is attained by using as a basic structure a sintered porous product having a skeleton formed by sintering of metal powder around voids, and forming a highly hydrophilic substance on the metal surface of the skeleton, for example, by coating treatment or self-production such as oxidation treatment. That is, because of the structure formed by surrounding of voids with sintered portions of metal powder, the member is composed of a skeleton portion capable of sucking up a liquid and void portions capable of storing the liquid, and the surface of the skeleton has an excellent wettability owing to the hydrophilicity-imparting treatment. Therefore, the member has a further improved liquid absorbing-and-holding capability.

A detailed explanation is given below. Because of the formation of the skeleton by sintering of metal powder, a liquid is absorbed at first owing to capillarity caused by the pores of the skeleton portion. The absorbed liquid oozes out into voids present around the skeleton portion to fill the voids therewith, whereby the liquid is held. In this process, since the skeleton of the liquid absorbing-and-holding member of the present invention has the highly hydrophilic substance formed thereon, the wettability of the surface of the skeleton is excellent, resulting in an improved absorbing-and-holding capability in the above process. In this case, when the enhancement of the hydrophilicity of the substance formed for the hydrophilicity-imparting treatment and optionally the reduction of the void size described hereinafter are carried out, the liquid-sucking-up action is improved by the help of the capillarity of the voids themselves. Depending on purpose of use, spaces can be secured also after the liquid absorption to assure air permeability, by setting the void size at a rather large size and making the voids intercommunicative.

In the present invention, since an absorbing-and-holding member for fuel for DMFC used in a mobile or an automobile is also supposed, the metal skeleton is used for improving the vibration resistance and the impact resistance and hence the metal powder is used as a starting material. In addition, a metallic material is suitable as a material for absorbing and holding a liquid because it generally has a high surface tension in itself and hence has a good wettability with the liquid and its wettability can be further improved by employing the hydrophilicity-imparting treatment according to the present invention. As to the kind of the metallic material, it is effective to choose a metallic material hardly affectable by a liquid to be absorbed and held by the use of the material. It is also possible to impart a function as a current-collecting plate or an electrode to the metallic material at the same time by utilizing the electroconductivity of the metal.

Although the hydrophilic substance formed on the skeleton in the present invention need not be particularly specified, various metal (including semi-metals) oxides and organic substances such as celluloses are effective as the hydrophilic substance. That is, it is conjectured that the oxides improve the wettability because oxygen in the oxide is hydrophilic. In addition, it is conjectured that the celluloses are effective as organic substances excellent in chemical resistance because they have an excellent hydrophilicity and are difficultly soluble in a liquid.

In the case of the metal (including semi-metals) oxides, the metal surface of the skeleton portion is coated with a highly hydrophilic substance such as a titanium oxide represented by titania, a chromium oxide represented by chromia, or a silicon oxide represented by silica. Aluminum oxide (alumina) may also be used. As a coating means, a solution of an alkoxide or the like of a metal to be converted to the metal oxide may also be used besides oxidation treatment, conversion treatment and chemical vapor deposition (CVD) treatment. In the case of coating treatment using the alkoxide, it is important to adjust the viscosity of the alkoxide solution to a low value so that the coating substance may not block up the pores of the skeleton portion.

A preferable structure according to the present invention is explained below.

(1) The pore size of the skeleton portion is preferably 200 μm or less on average.

This range is for assuring the sufficient liquid-sucking-up capability due to capillarity of the skeleton portion.

(2) The void size is preferably 3,000 μm or less on average.

This is because the absorbing properties and holding properties for a liquid tend to be deteriorated when the void size is too large. It can be speculated that the deterioration is caused because gravity applied to a liquid stored in voids surpasses an action of drawing up the stored liquid. It is conjectured that a small void size is advantageous because it accelerates capillarity as in the case of the pores of the skeleton portion, permits stable holding of a liquid in the voids, and contributes also to the absorption.

(3) The porosity content of the whole porous material is preferably not more than 95% by volume and not less than 60% by volume.

This is because the increase of voids for holding a liquid is advantageous for increasing the amount of the liquid held in the porous material. In addition, when the voids are isolated from one another by the skeleton portion, the skeleton portion is previously filled with the liquid because the movement of the liquid is rapid in the skeleton portion owing to capillary force. As a result, when the voids are tightly covered with the skeleton portion, air in the voids hardly escapes, so that entrapped air is likely to be produced to inhibit the liquid from entering the voids. For preventing this inhibition, it is effective to improve the inter-communication of the voids to a certain degree so that when the liquid enters the voids, air in the voids can be eliminated from the porous material as much as possible. For the above reasons, the porosity content of the whole porous material is preferably 60% by volume or more.

However, on the other hand, it is necessary to assure a sufficient volume percentage of the skeleton portion for assuring the strength of the porous material itself and a sufficient liquid-absorbing-capacity. Therefore, the porosity content of the whole porous material is preferably 95% by volume or less.

The porous liquid absorbing-and-holding member of the present invention is more preferably as follows: in the sintered product having the skeleton formed thereon, the skeleton is a sintered skeleton of metal powder having an average particle size of 100 μm or less, the pore size of the skeleton portion is 5 to 100 μm on average, the void size is 100 to 2,000 μm on average, and the porosity content of the whole porous material is 70 to 90% by volume.

As a process for producing the porous material used in the present invention, the following process, for example, can be adopted.

At first, metal powder is prepared. As the metal powder, stainless steel, titanium, titanium alloys and the like, but not materials easily corrodible by a liquid to be brought into contact with them, are effective. As to the particle size of the metal powder, its average particle size is preferably 200 μm or less, more preferably 100 μm or less.

The metal powder is mixed with resin particles and a binder. As the resin particles, resin particles having an average particle size of 100 to 3,000 μm are preferable for assuring the void size. Although a resin may also be used as the binder, it is effective to use, for example, a binder composed mainly of methyl cellulose and water which is insoluble in a solvent, when an effective method comprising removal of the resin particles by the use of the solvent is adopted.

Then, from the kneaded product thus obtained, a molded product is produced, debound by heating and then sintered. Here, when water is incorporated into the above-mentioned binder, a drying step is preferably added after the molding. When the resin particles are removed by the use of the solvent, steps of solvent extraction and drying are preferably added before the debinding by heating.

The porous material obtained by the sintering is preferably subjected to the following hydrophilicity-imparting treatment, whereby it is possible to obtain the porous liquid absorbing-and-holding member of the present invention in which the skeleton formed by sintering of the metal powder around voids has a hydrophilic substance formed thereon. This member can be used as an alcohol absorbing-and-holding member.

The process for producing a porous liquid absorbing-and-holding member of the present invention is explained below. The important characteristic of the production process of the present invention is to utilize a special chemical vapor deposition method (CVD method) for carrying out hydrophilicity-imparting treatment for forming a highly hydrophilic substance on the surface of the skeleton of a porous sintered product used as a substrate for the member. The term “hydrophilicity-imparting treatment” used herein means a treatment for improving the wettability with, in particular, water or an organic compound having a hydroxyl group.

First, in the production process of the present invention, the hydrophilic substance formed on the skeleton is a metal oxide. The reason is as follows. The metal oxide is excellent in adhesive properties to the skeleton made of metal and moreover, it is generally a chemically stable substance and hence is advantageous in that it permits prevention of a corrosion problem caused when the porous liquid absorbing-and-holding member is used in a water-containing liquid as in the present invention and various problems caused by various reactions. In addition, the wettability is improved because oxygen in the metal substance is hydrophilic. The metal oxide referred to herein includes semi-metal oxides.

The production process of the present invention is characterized particularly in that a special method, i.e., a plasma CVD method is used in the process in order to form the above-mentioned metal oxide on the skeleton surface. The plasma CVD method is a method in which a compound containing a starting material is decomposed by the use of plasma to cause a chemical reaction and form a substance film on the surface of a heated substrate (an object to be treated). In the present invention, an organometallic compound is used as a starting material and a starting gas obtained by vaporizing this compound is reacted with a plasma gas containing oxygen at a pressure close to atmospheric pressure, to form a metal oxide on the surface of the above-mentioned skeleton.

The reason why the organometallic compound is used as a starting material is that even if the vapor pressure of its metal is low, the compound can easily be gasified and then fed to a reaction chamber. In addition, a thin film having any of various compositions can be grown by changing the gas. As to the decomposition of the starting gas obtained by the vaporization, by the use of plasma gas, the starting gas can be decomposed at a lower temperature as compared with a conventional thermal CVD method. Therefore, the thermal deformation of the substrate itself and peeling of the metal oxide from the substrate by the difference between them in thermal expansion can be suppressed. The filmy oxide formed by the plasma CVD method is dense and is good in throwing power even on the inner surface of the substrate even when the shape of the substrate is complicated like that of the porous material used in the present invention. Therefore, the filmy oxide is most suitable particularly for the surface treatment of the complicated skeleton of the metallic porous material which is intended in the present invention.

For introducing oxygen necessary for producing the metal oxide used in the present invention, a large-scale apparatus such as a high-vacuum chamber like that used in a vacuum plasma CVD method is not necessary because a plasma gas containing oxygen at a pressure close to atmospheric pressure can be used. That is, film-forming treatment substantially in the air is possible and the treatment can be continuously carried out. Therefore, the apparatus cost can be greatly reduced and the productivity is high. The term “a pressure close to atmospheric pressure” means a pressure in the range of about 13 to 200 kPa, preferably a pressure of about 100 kPa. A pressure in the above range is considered herein as atmospheric pressure.

The present inventor ascertained that in using the above-mentioned plasma gas, the following is very effective for stable formation of the metal oxide: preferably, the plasma gas is passed upward from below a porous material to be treated, to form the metal oxide by reaction on the surface of skeleton of the porous material (FIG. 16). The reason for this effectiveness is as follows: since the plasma gas used for forming the oxide is in a heated state at about 400° C. and flows upward owing to a rising current of air, passing the plasma gas upward gives the direction of the smoothest flow not contrary to the flow of the gas.

As a method for forming the metal oxide on the skeleton of the porous material, there is also another method using a solution of an alkoxide or the like of a metal to be converted to the metal oxide. When coating treatment using the alkoxide is carried out particularly on the sintered skeleton, it is important to adjust the viscosity of the alkoxide solution to a low viscosity so that the coating material may not block up the pores of the skeleton portion. Therefore, strict control is necessary. On the other hand, the CVD method adopted in the present invention is advantageous in that the metal oxide can be formed while securing the pores certainly.

As the metal oxide formed so as to cover the metal skeleton in the present invention, silicon oxides, titanium oxides, chromium oxides and aluminum oxides can be selected as highly hydrophilic substances. Of these, the silicon oxides are preferably selected which are most commonly used in the field of semiconductors, because this selection is advantageous from the viewpoint of starting material and cost.

### DESCRIPTION OF PREFERRED EMBODIMENT

### EXAMPLE 1

SUS316L powder obtained by water atomization and having an average particle size of 60 μm, commercial methyl cellulose and two kinds of spherical paraffin wax particles with average particle sizes of 1,000 μm and 180 μm, respectively, as rein particles were mixed and then kneaded with water and a plasticizer to prepare a kneaded product. The amount of the resin particles mixed was set as follows: when the total volume of the metal powder and the resin particles was taken as 100%, the proportions of the paraffin wax particles with an average particle size of 1,000 μm and the paraffin wax particles with an average particle size of 180 μm were 75% and 12.5%, respectively, and the balance 12.5% was of the metal powder.

The above-mentioned kneaded product was press-molded into a plate under a load of 0.8 MPa, and this molded product was dried at 50° C. The paraffin wax particles in the molded product were extracted with a solvent and the molded product thus treated was dried at 70° C. Subsequently, the molded product was heated at a rate of 40° C./h in a nitrogen atmosphere in a debinding furnace and maintained at 600° C. for 2 hours. By this procedure, the residual paraffin wax and the binder were decomposed and vaporized. Then, the molded product was sintered by its maintenance at 1,170° C. for 2 hours in hydrogen in a sintering furnace, to obtain a disk of porous material having a thickness of 3 mm.

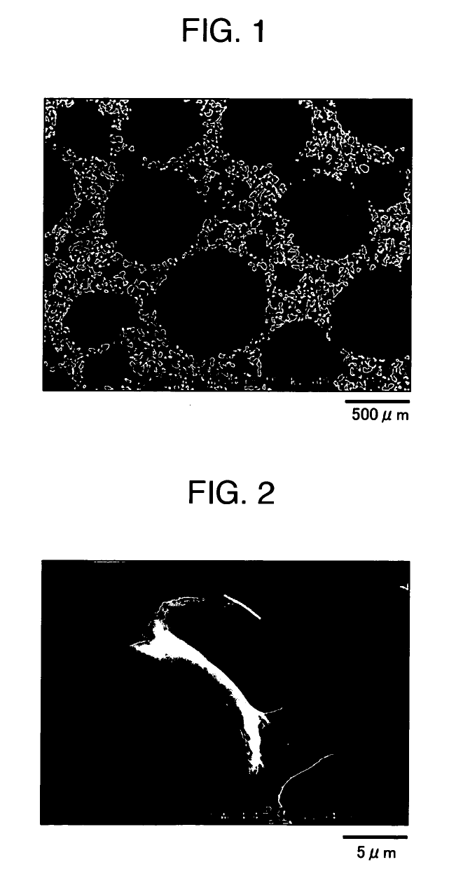

The microscopic shape of section of the porous sintered product obtained is shown in the scanning electron microscope (SEM) photograph in FIG. 1. The blank portions show metal portions and the dark portions show voids and spaces constituting the pores of the skeleton portion. The pore size of the skeleton portion was measured by a mercury injection method and found to be 79.4 μm on average. As the voids, there are confirmed two kinds of voids, i.e., small voids that look dispersed in the skeleton and large voids that do not look dispersed in the skeleton. On the basis of the section micrograph, it was found that the diameter of the small voids was 150 μm on average, the diameter of the large voids 660 μm on average, the diameter of whole voids 510 μm on average, and the porosity content of the whole porous material 84.8%.

A stock (105 mm long, 20 mm wide and 3 mm thick) was cut out of the porous sintered product and set in a plasma gas producing apparatus for forming a metal oxide on the surface of the internal skeleton. The setting was conducted as follow: as shown in FIG. 16, a schematic view of the apparatus, the surface on which the oxide was to be formed was placed downward, so that a plasma gas might be brought into contact with this surface from below the surface. TEOS (tetraethoxysilane) was used as a starting organometallic compound. While feeding this starting material at a rate of 0.2 g/min to the surface of the substrate from the side by using nitrogen gas as a carrier gas, a 1:1 (by volume) mixed gas of oxygen and nitrogen converted to plasma at atmospheric pressure was passed upward toward the surface to be treated of the substrate, to be reacted with the starting gas, whereby a precursor of film was formed. The precursor accumulated on the surface of the porous sintered product to form a silicon oxide film. By the above atmospheric plasma CVD treatment, the surface of the skeleton portion was coated with silica for 5 minutes to produce a test piece.

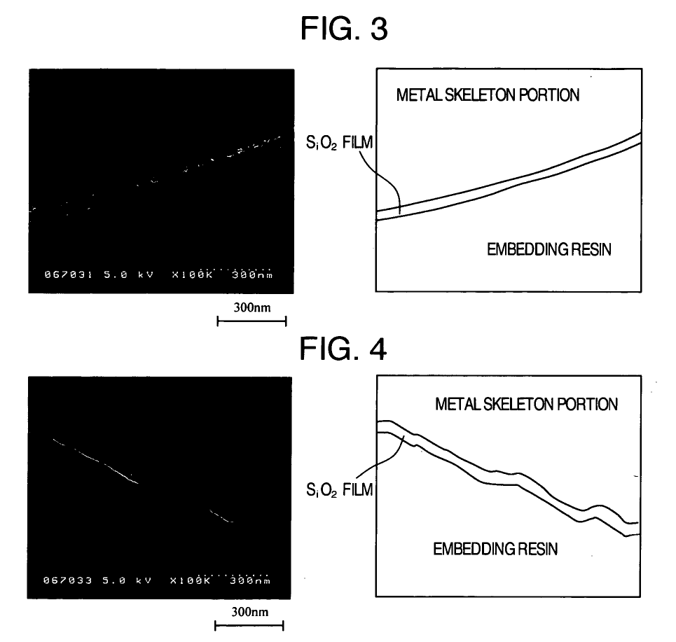

FIG. 2 is a SEM photograph showing the metal surface of the skeleton after the CVD treatment. It can be seen from FIG. 2 that the pores are not blocked up by the coating material. The SEM photograph in FIG. 3 shows a section of the skeleton surface in the vicinity of the treated surface of the test piece. As shown in FIG. 3, a silicon oxide (SiO₂) film of about 60 nm in thickness was formed. The SEM photograph in FIG. 4 shows a section of the skeleton surface at a distance of 1.5 mm from the treated surface of the test piece. As shown in FIG. 4, a silicon oxide film of about 30 nm in thickness was formed. As a result of analysis with an energy dispersion X-ray analyzer (EDX), the silicon and oxygen contents of the metal surface layer of the skeleton portion were found to be higher than before the CVD treatment, and it was found that even the skeleton surface inside the test piece had been thinly and uniformly coated with silicon oxide.

### EXAMPLE 2

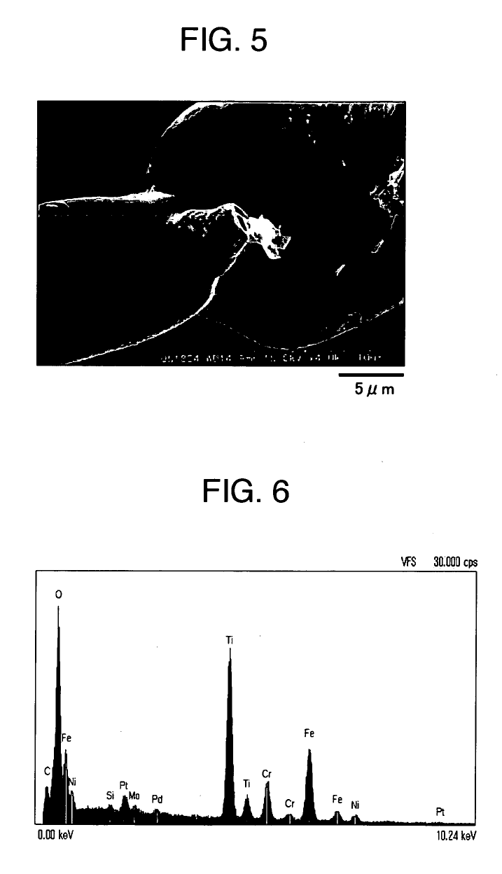

A porous sintered product (105 mm long, 20 mm wide and 3 mm thick) obtained in the same manner as in Example 1 was washed, coated with a peroxotitanic acid solution and then heat-treated at 400° C. in the air to produce a test piece. FIG. 5 is a SEM photograph showing the metal surface of the skeleton portion. Scaly precipitate portions are observed on the surface and it can be seen that the pores are not blocked up. FIG. 6 shows the result of EDX analysis of the precipitate portions. The precipitate portions were found to have high titanium and oxygen contents and it was confirmed that titanium oxide had been precipitated on the metal surface though nonuniformly.

### EXAMPLE 3

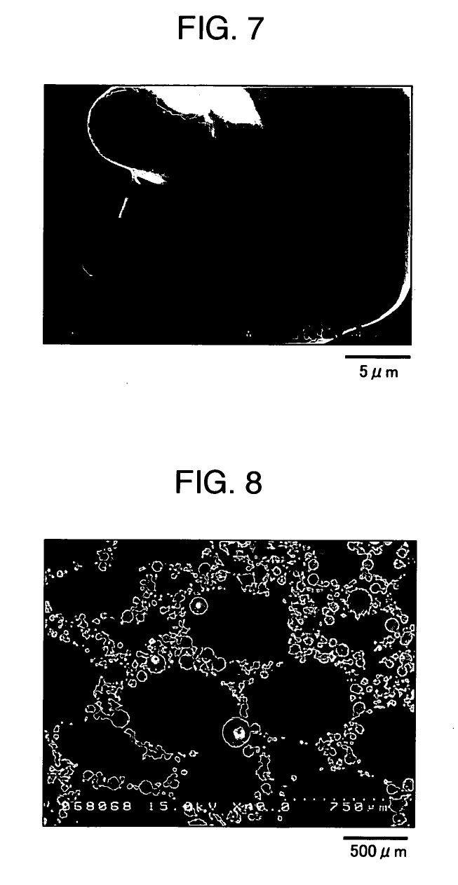

A porous sintered product (105 mm long, 20 mm wide and 3 mm thick) obtained in the same manner as in Example 1 was washed and then subjected to passive-state treatment with 60% concentrated nitric acid to form a chromium oxide coating film on the metal surface of the skeleton. FIG. 7 is a SEM photograph of the metal surface of the skeleton portion. It can be seen from FIG. 7 that the pores are not blocked up. As to the chromium oxide, the chromium and oxygen contents of the metal surface layer of the skeleton portion were found to be higher than before the treatment as a result of EDX analysis, and it was confirmed that the skeleton surface had been thinly and uniformly coated with the chromium oxide.

### EXAMPLE 4

A kneaded product was prepared in the same manner as in Example 1 except for using Fe-3 (mass %) Cr-5 (mass %) Al −0.5 (mass %) Zr powder obtained by gas atomization and having an average particle size of 52 μm, in place of the SUS316L powder obtained by water atomization. The amount of the resin particles mixed was set so that the proportions of the paraffin wax particles with an average particle size of 1,000 μm and the paraffin wax particles with an average particle size of 180 μm might be 80% and 10%, respectively, and that the balance 10% might be of the metal powder. A disc of porous material having a thickness of 5.5 mm was obtained from the kneaded product in the same manner as in Example 1.

The microscopic shape of section of the porous sintered product obtained is shown in the SEM photograph in FIG. 8. Although the microscopic shape was the same as in FIG. 1, the pore size of the skeleton portion was 83.1 μm. As to two kinds of confirmed voids, i.e., large voids and small voids, it was found on the basis of the section micrograph that the diameter of the small voids was 120 μm on average, the diameter of the large voids 560 μm on average, and the average diameter of all the voids 290 μm. The porosity content of the whole porous material was 83.7%.

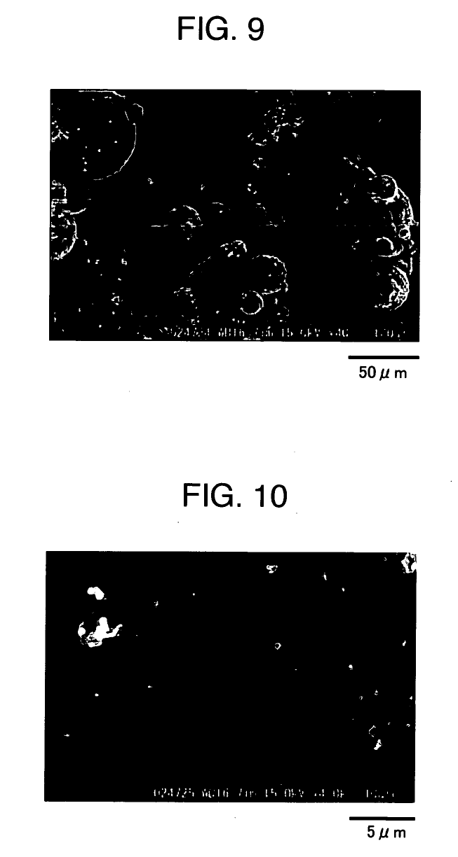

A stock (80 mm long, 20 mm wide and 5.5 mm thick) was cut out of the porous sintered product and coated by precipitating aluminum oxide on the surface of the skeleton portion by high-temperature oxidation treatment at 1,100° C. for 1 hour in the air, to produce a test piece. FIG. 9 is a SEM photograph of the skeleton portion after the high-temperature oxidation treatment. It can be seen from FIG. 9 that the pores are not blocked up by the coating material. FIG. 10 is a SEM photograph showing the metal surface of the skeleton portion. As a result of EDX analysis, the aluminum and oxygen contents of the metal surface layer of the skeleton portion were found to be higher than before the oxidation treatment and it was found that the skeleton surface had been coated with aluminum oxide.

### Comparative Examples 1 and 2

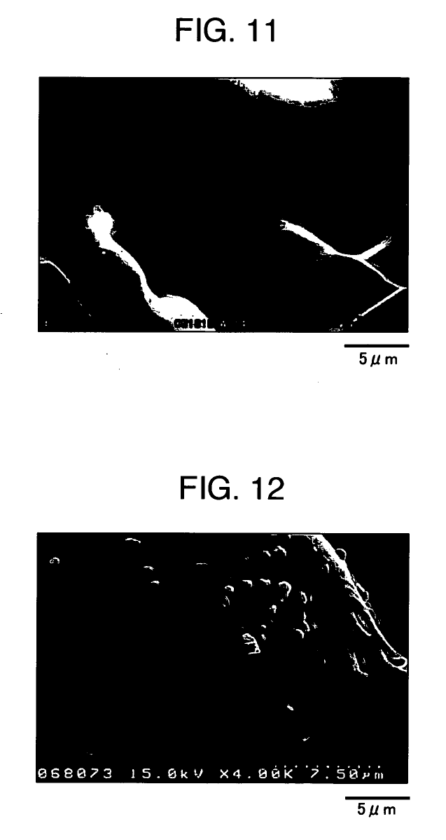

A porous sintered product (105 mm long, 20 mm wide and 3 mm thick) obtained in the same manner as in Example 1 and a porous sintered product (80 mm long, 20 mm wide and 5.5 mm thick) obtained in the same manner as in Example 4 were used as they were without hydrophilicity-imparting treatment. The former was used as a test piece of Comparative Example 1 and the latter as a test piece of Comparative Example 2. FIG. 11 is a SEM photograph showing the metal surface of skeleton portion of the test piece of Comparative Example 1, and FIG. 12 is a SEM photograph showing the metal surface of skeleton portion of the test piece of Comparative Example 2.

(Evaluation)

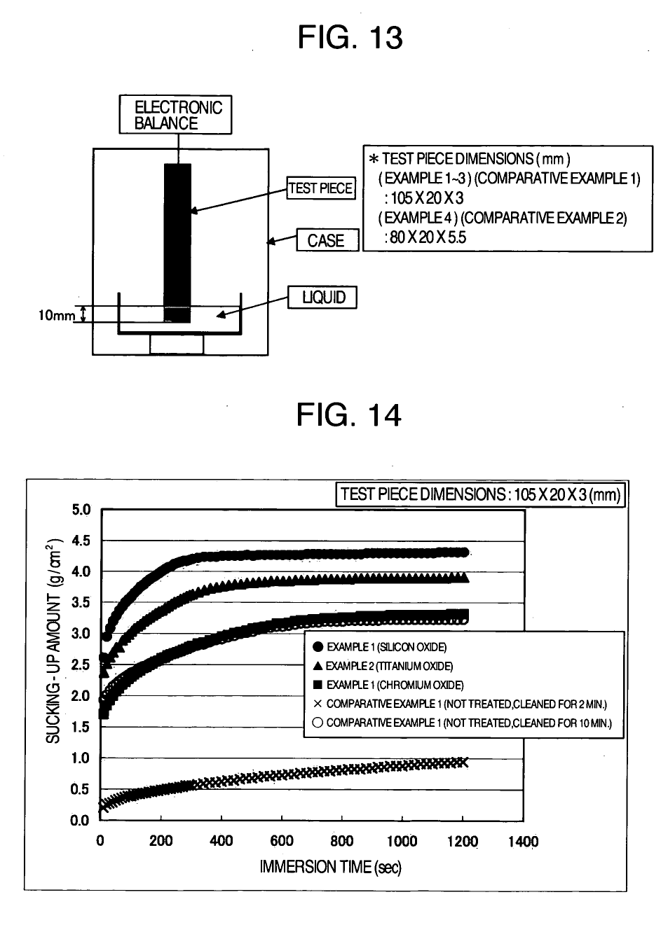

Each of the above-mentioned test pieces, i.e., the test pieces of Examples 1 to 4 obtained according to the present invention and the test pieces of Comparative Examples 1 and 2 was suspended in a case from an electronic balance as shown in FIG. 13, 10 mm of the lower end of each test piece was immersed in a liquid for test, and the change of the amount of the liquid sucked up per unit sectional area of the test piece with the immersion time was measured. As the liquid for test, an aqueous methanol solution having a methanol concentration of 10 mass % was used as an imaginary methanol solution used in DMFC.

At first, comparison of the test pieces of Examples 1 to 3 and Comparative 1 is described below with respect to their sucking-up capability for the liquid. Since the result of the evaluation test described above is likely to change markedly depending on the condition of surface of even one and the same test piece, care was taken to allow the surface of each test piece before the test to assume the same condition by subjecting the test piece to ultrasonic cleaning with ethanol for 2 minutes, followed by drying at 50° C. for 5 hours, before the test. In the case of the test piece of Comparative Example 1, not only the test piece cleaned and then dried under the above conditions but also that cleaned for 10 minutes and then dried at 50° C. for 5 hours were evaluated.

The graph in FIG. 14 shows the change of the amount of the liquid sucked up per sectional area of each of the test pieces of Examples 1 to 3 and Comparative Example 1 with the immersion time. It can be seen from the graph that the test pieces of Examples 1 to 3 obtained by coating the skeleton of a porous sintered product with each oxide by hydrophilicity-imparting treatment have a higher absorbing capability than does the test piece of Comparative Example 1 not subjected to hydrophilicity-imparting treatment after sintering and subjected to cleaning and drying under the same conditions as above, and that the values of the sucking-up amount after 20 minutes (1,200 seconds) of the test pieces of Examples 1 to 3 are about 4.6 times, about 4.1 times and 3.5 times, respectively, that of the test piece of Comparative Example 1.

In the case of Comparative Example 1, the test piece cleaned with ethanol for 10 minutes before the test was substantially equal in sucking-up amount to the test piece of Example 3 obtained by coating with chromium oxide according to the present invention, namely, it had an improved absorbing-and-holding capability. However, when after the test, this test piece of Comparative Example 1 was dried, allowed to stand for 1 week and then subjected to the same test as above once more as it was, it was confirmed that this test piece had a deteriorated absorbing-and-holding capability substantially equal to the result in FIG. 14 obtained for the test piece of Comparative Example 1 cleaned with ethanol for 2 minutes. That is, the effect of the cleaning for 10 minutes does not last. On the other hand, the test pieces of Examples 1 to 3 obtained by the hydrophilicity-imparting treatment according to the present invention had an unchanged sucking-up amount in a retest even when allowed to stand for 1 week similarly. Thus, it was confirmed that their sucking-up capability is hardly changed with the lapse of time and that their excellent absorbing-and-holding capability lasts.

Next, comparison between the test pieces of Example 4 and Comparative 2 is described below with respect to their sucking-up capability for the liquid. In this case, as to cleaning conditions before the above-mentioned test, care was taken to allow the surface of each test piece before the test to assume the same condition by subjecting the test piece to ultrasonic cleaning with ethanol for 10 minutes, followed by drying at 50° C. for 5 hours.

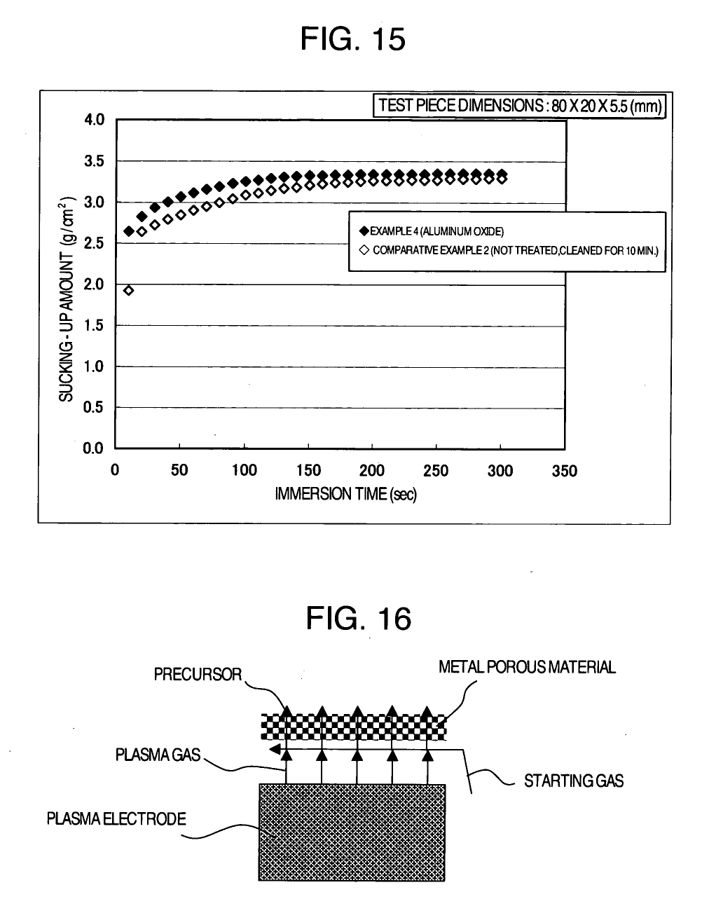

The graph in FIG. 15 shows the change of the amount of the liquid sucked up per sectional area of each of the test pieces of Example 4 and Comparative Example 2 with the immersion time. It can be seen from the graph that the test piece of Example 4 obtained by coating the skeleton of a porous sintered product with aluminum oxide by high-temperature oxidation treatment (hydrophilicity-imparting treatment) has a higher absorbing capability than does the test piece of Comparative Example 2 not subjected to hydrophilicity-imparting treatment and subjected to cleaning and drying under the same conditions as above, and that the sucking-up amount 10 seconds after the immersion of the test piece of Example 4 is about 1.4 times that of the test piece of Comparative Example 2. This improvement ratio corresponds to the ratio of the sucking-up amount of the test piece of Example 1 to that of the test piece of Comparative Example 1 cleaned for 10 minutes.

It is conjectured that the reason why the time required for the sucking-up amount to reach saturation was short and there was no marked difference in sucking-up amount at the time of saturation, as compared with the result of the test using the test pieces of Examples 1 to 3 and Comparative Example 1, is that the length of the test pieces is as short as 80 mm.

Since the porous liquid absorbing-and-holding member of the present invention has a high absorbing capacity for a liquid owing to capillarity and its porous material itself has a structure capable of holding a large amount of the liquid, it can be expected to be usable not only as an absorbing-and-holding member for an alcohol used as a fuel for fuel cell but also as a member for absorbing water produced on an air electrode side or a substrate for the electrode of a secondary cell or a capacitor, and the porous liquid absorbing-and-holding member can be expected to be usable also for producing them.

1. A porous liquid absorbing-and-holding member comprising a porous sintered product having a skeleton formed by sintering of metal powder around voids and subjected to hydrophilicity-imparting treatment.

2. A porous liquid absorbing-and-holding member according to claim 1, wherein the hydrophilicity-imparting treatment is the formation of one or more substances selected from the group consisting of silicon oxides, titanium oxides, chromium oxides and aluminum oxides on the skeleton.

3. A porous liquid absorbing-and-holding member according to claim 1, wherein its skeleton portion has pores with an average pore size of 200 μm or less, the average void size is 3,000 μm or less, and the porosity content of the whole porous material is not more than 95% by volume and not less than 60% by volume.

4. A porous liquid absorbing-and-holding member according to claim 3, wherein its skeleton portion has pores with an average pore size of 5 to 100 μm, the average void size is 100 to 2,000 μm, and the porosity content of the whole porous material is not more than 90% by volume and not less than 70% by volume.

5. A process for producing a porous liquid absorbing-and-holding member by adopting a method for subjecting the skeleton of a porous sintered product having the skeleton formed by sintering of metal powder around voids to hydrophilicity-imparting treatment, which comprises carrying out the hydrophilicity-imparting treatment by using an organometallic compound as a starting material, and reacting a starting gas obtained by vaporizing this compound with a plasma gas containing oxygen at a pressure close to atmospheric pressure, to form a metal oxide on the surface of the skeleton.

6. A process for producing a porous liquid absorbing-and-holding member according to claim 5, wherein the plasma gas containing oxygen at a pressure close to atmospheric pressure is passed upward from below the porous sintered product to form the metal oxide on the surface of the skeleton.

7. A process for producing a porous liquid absorbing-and-holding member according to claim 5, wherein the metal oxide is a silicon oxide.

8. An alcohol absorbing-and-holding member comprising a porous liquid absorbing-and-holding member according to claim 1 into which an alcohol is absorbed to be held therein.

9. An alcohol absorbing-and-holding member comprising a porous liquid absorbing-and-holding member according to claim 3 into which an alcohol is absorbed to be held therein.

10. An alcohol absorbing-and-holding member comprising a porous liquid absorbing-and-holding member according to claim 4 into which an alcohol is absorbed to be held therein.
